(19) United States
(12) Patent Application Publication
(10) Pub. No.: US 2019/0367806 A1
(43) Pub. Date: Dec. 5, 2019

(54) TUNABLE ROOM-TEMPERATURE SINGLE-PHOTON EMISSION AT TELECOM WAVELENGTHS FROM SP3 DEFECTS IN CARBON NANOTUBES

(71) Applicant: Triad National Security, LLC, Los Alamos, NM (US)

(72) Inventors: Han Htoon, Los Alamos, NM (US); Stephen K. Doorn, Los Alamos, NM (US); Xiaowei He, Los Alamos, NM (US)

(73) Assignee: Triad National Security, LLC, Los Alamos, NM (US)

(21) Appl. No.: 16/427,633

(22) Filed: May 31, 2019

Related U.S. Application Data
(60) Provisional application No. 62/678,639, filed on May 31, 2018.

(51) Int. Cl. C09K 11/06; C01B 32/168; C01B 32/159; B01J 19/12; C09K 11/02

(52) U.S. Cl. CPC C09K 11/06; C01B 32/168; C01B 32/159; B01J 19/121; B82Y 40/00; C01B 2202/02; B01J 2219/12; B01J 2219/0877; C09K 2211/1003; C09K 11/025

(57) ABSTRACT

Techniques for generating quantum light emitters that operate at room temperature and at telecom wavelengths are described. Quantum light emitters of the present disclosure may have various structures. For examples, an SWCNT may chirality of (6,5), (7,5), or (10,3). Quantum light emitters of the present disclosure may be doped with various compounds. In at least some examples, an SWCNT may be doped with an aryl dopant. In at least some examples, the aryl dopant may be an aryl diazonium dopant. Example aryl diazonium dopants include, but are not limited to, 3,5-dichlorobenzenediazonium (Cl₂-Dz) and 4-methoxybenzenediazonium (MeO-Dz). Quantum light emitters of the present disclosure may be encapsulated in various materials. In at least some examples, an SWCNT may be encapsulated in a surfactant. An example surfactant is sodium deoxycholate (DOC). In at least some other examples, an SWCNT may be encapsulated in a polymer. In at least some examples, the polymer may be a polyfluorene polymer. An example polyfluorene polymer is a copolymer of 9,9-dioctylfluorenyl-2,7-diyl and bipyridine (PFO-BPy).

### CROSS-REFERENCE TO RELATED APPLICATION

This application claims the benefit of priority of U.S. Provisional Patent Application No. 62/678,639, filed on May 31, 2018, and titled “TUNABLE ROOM-TEMPERATURE SINGLE-PHOTON EMISSION AT TELECOM WAVELENGTHS FROM SP³ DEFECTS IN CARBON NANOTUBES,” the contents of which is expressly incorporated herein by reference in its entirety.

### STATEMENT REGARDING FEDERALLY SPONSORED RESEARCH OR DEVELOPMENT

The United States government has rights in this invention pursuant to Contract No. 89233218CNA000001 between the United States Department of Energy (DOE), the National Nuclear Security Administration (NNSA), and Triad National Security, LLC for the operation of Los Alamos National Laboratory.

### BACKGROUND

Generating quantum light emitters that operate at room-temperature (room-T) and at telecom wavelengths is a significant materials challenge.

Single-photon sources (SPSs) are the enabling materials required for quantum photonics, quantum information processing, and quantum computing, and are of interest for ultrasensitive metrology and sensing applications. In particular, room-T SPSs emitting at telecom wavelengths (e.g., 1.3-1.55 μm) are required for fiber-based quantum information technology, providing ease of integration to existing low-loss fiber-optic telecommunication networks. While a number of low-dimensional (e.g, less than 3) and nanoscale materials have demonstrated promise as quantum light sources, achieving room-T single-photon emission (SPE) at telecom wavelengths remains an elusive goal.

Room-T SPE is available from defect centres in large band gap semiconductors (e.g., having bandgaps in the range of about 2-4 eV), including color centers in diamond and silicon carbide, but their inherent band structure limits operating wavelengths to the visible region. In contrast, SPE at telecom wavelengths has been demonstrated in III-V semiconducting quantum dots (QDs), but to date these have been limited to cryogenic operation. Harnessing exciton (e.g., a concentration of energy in a crystal formed by an excited electron and an associated hole) localization at defect sites in low-dimensional nanomaterials is rapidly emerging as an alternative means to generate single photons.

SPE in 2D WSe₂ monolayers has been observed at liquid helium (He) temperatures from intrinsic defect sites. Defects in hexagonal BN afford room-T SPE, provide some degree of tunability, yet remain limited to wavelengths shorter than about 760 nm. Exciton localization at liquid He temperature in shallow potentials (on the order of a few meV) resulting from fluctuations in single-wall carbon nanotube (SWCNT) surface environments promote observation of SPE in SWCNTs at cryogenic T.

While oxygen functionalization has opened the possibility of room-T SPE based on SWCNTs, this approach suffers from an inherent emission instability due to the nature of the oxygen defect sites. Furthermore, the incorporated oxygen functionality offers little opportunity for synthetic control over emitting properties. Density functional theory (DFT) modeling of the oxygen defect sites indicates they create a significant perturbation of the SWCNT electrostatic environment, which in turn promotes charge-induced photoluminescence blinking or intermittency.

### SUMMARY

Generating quantum light emitters that operate at room temperature (T) and at telecom wavelengths may require light sources that emit in the near-infrared (IR) wavelength region and that are tunable in order to allow accessing desired output wavelengths in a controllable manner. The present disclosure demonstrates that exciton localization at covalently-introduced aryl sp³ defect sites in single-wall carbon nanotubes (SWCNTs) provides a route to room-T single-photon emission (SPE) with ultra-high single-photon purity (99%) and enhanced emission stability approaching the shot-noise limit. Moreover, the present disclosure demonstrates the tunability of SWCNTs, present in their structural diversity, that permit generation of room-T SPE spanning the entire telecom band. SPE deep into the centre of the telecom C band (e.g., 1.55 μm) is achieved at at least nanotube diameters of 0.936 nm.

Covalent oxygen functionalization of SWCNTs has been used to introduce defect states that both localize excitons and shift photoluminescence emission to longer wavelengths. Because these oxygen defects introduce exciton trapping potentials with 100-300 meV depths, exciton localization persists at room-T, providing a route to room-T SPE in SWCNTs, with emission wavelengths below 1.3 μm. Compared to other low-dimensional materials, SWCNTs offer a number of advantages as potential single-photon sources, including broad tunability of optical properties through access to a large range of semiconducting nanotube structures (designated by the indices (n,m)), which photoluminesce in the near-IR spectral region. SWCNTs are also natural systems for integration into nano-optoelectronic devices, complex electro-optic circuitry, and incorporation into plasmonic and photonic cavities for further enhancement and manipulation of photoluminescence behaviors.

Density functional theory (DFT) results indicate that introduction of aryl sp³ defects as exciton localization centers should significantly reduce perturbation of the local electrostatic environment in a SWCNT. The present disclosure introduces trap states at energies greater than 130 meV below the band-gap of SWCNT via covalently-bound sp³ defects by reaction of SWCNTs with aryl diazonium species. By also incorporating the functionalized SWCNT into reduced-polarity matrices, the present disclosure demonstrates a route to room-T SPE with ultrahigh emission stability. By combining the wavelength tunability of SWCNTs with the synthetic flexibility of aryl functionalization agents, the present disclosure achieves the long-desired goal of establishing room-T single-photon emitters, with single-photon purity of 99%, that match the most efficient telecom wavelengths (e.g., 1.3 μm and 1.55 μm).

An aspect of the present disclosure relates to a method including obtaining a single-wall carbon nanotube, doping the single-wall carbon nanotube to provide a doped single-wall carbon nanotube, and causing the doped single-wall carbon nanotube to emit single photons at room temperature. In at least some examples, the causing step of the method may include exposing the doped single-wall carbon nanotube to at least one of about 840 nm or about 870 nm femtosecond laser pulses. In at least some examples, the femtosecond laser pulses are performed at a repetition rate of about 90 MHz. In at least some examples, the causing step of the method may include exposing the doped single-wall carbon nanotube to a continuous output of a Ti:Sapphire laser. In at least some examples, the continuous output is one of about 840 nm or about 870 nm. In at least some examples, the doped-single-wall carbon nanotube has a chirality of (6,5), and the single photons are emitted at wavelengths of about 840 nm to about 1000 nm. In at least some examples, the doped single-wall carbon nanotube has a chirality of (7,5), and the single photons are emitted at wavelengths of about 840 nm to about 1030 nm. In at least some examples, the doped single-wall carbon nanotube has a chirality of (10,3), and the single photons are emitted at wavelengths of about 840 nm to about 1230 nm. In at least some examples, the doped single-wall carbon nanotube has at least one sp³ defect site.

Another aspect of the present disclosure relates to a single photon source including a single-wall carbon nanotube capable of emitting single photons at room-temperature. In at least some examples, the single-wall carbon nanotube has a (6,5) chirality. In at least some examples, the single-wall carbon nanotube has a (7,5) chirality. In at least some examples, the single-wall carbon nanotube has a (10,3) chirality. In at least some examples, the single-wall carbon nanotube is doped with an aryl compound including diazonium. In at least some examples, the aryl compound includes 3,5-dichlorobenzenediazonium (Cl₂-Dz). In at least some examples, the aryl compound includes 4-methoxybenzenediazonium (MeO-Dz). In at least some examples, the single-wall carbon nanotube is encapsulated in at least one of a surfactant or a polymer. In at least some examples, the surfactant includes sodium deoxycholate (DOC). In at least some examples, the polymer includes a polyfluorene polymer. In at least some examples, the polymer includes 9,9-dioctylfluorenyl-2,7-diyl and bipyridine (PFO-BPy).

### BRIEF DESCRIPTION OF DRAWINGS

For a more complete understanding of the present disclosure, reference is now made to the following description taken in conjunction with the accompanying drawings.

FIGS. 1A and 1B illustrate exciton localization and wavelength-tunable defect-state emission (E₁₁*) in aryl-functionalized single-wall carbon nanotubes SWCNTs of varying (n,m) according to embodiments of the present disclosure.

FIGS. 2A through 2L illustrate photoluminescence characteristics and photon antibunching properties of sp³ defect-state emission (E₁₁*) from aryl-functionalized (6,5), (7,5), and (10,3) SWCNTs according to embodiments of the present disclosure.

FIGS. 2M and 2N illustrate photoluminescence characteristics and photon antibunching properties of sp³ defect-state emission (E₁₁*) from aryl-functionalized (11,0) SWCNTs according to embodiments of the present disclosure.

FIGS. 2O through 2Q illustrate photoluminescence characteristics and photon antibunching properties of sp³ defect-state emission (E₁₁*) from aryl-functionalized (10,5) SWCNTs according to embodiments of the present disclosure.

FIGS. 3A through 3C illustrate global trends in single photon emission statistics and dynamics over a complete range of SWCNT (n,m) and observed E₁₁* emission wavelengths according to embodiments of the present disclosure.

FIG. 4A illustrates room-temperature (room-T) ensemble photoluminescence spectra of Cl₂-Dz and MeO-Dz functionalized (6,5), (7,5), and (10,3) SWCNTs in aqueous 1% DOC suspensions according to embodiments of the present disclosure.

FIG. 4B illustrates statistics of photoluminescence spectra for individual nanotubes in comparison to ensemble spectrum according to embodiments of the present disclosure.

FIG. 5A illustrates room-T photoluminescence spectra of a single (6,5) SWCNT functionalized by MeO-Dz according to embodiments of the present disclosure.

FIG. 5B illustrates room-T photoluminescence spectra of a single (6,5) SWCNT functionalized by Cl₂-Dz according to embodiments of the present disclosure.

FIG. 6 illustrates defect-state photoluminescence intensity saturation behavior according to embodiments of the present disclosure.

FIG. 7A illustrates a full g⁽²⁾ trace of DOC wrapped (6,5) tubes doped by Cl₂-Daz and emitting at ˜1.25 μm according to embodiments of the present disclosure.

FIG. 7B illustrates magnification of a central part of FIG. 7A around t=0, and indicating g⁽²⁾(0) at the zero delay time according to embodiments of the present disclosure.

FIG. 8A illustrates a full g⁽²⁾ trace of FIG. 2B according to embodiments of the present disclosure.

FIG. 8B illustrates a full g⁽²⁾ trace of FIG. 2F according to embodiments of the present disclosure.

FIG. 8C illustrates a full g⁽²⁾ trace of FIG. 2J according to embodiments of the present disclosure.

FIGS. 9A, 9E, 9I, 9M, 9Q, and 9U illustrate photoluminescence spectra according to embodiments of the present disclosure.

FIGS. 9B, 9F, 9J, 9N, 9R, and 9V illustrate photoluminescence time traces with corresponding σ_{QE}/σ_{SN} values according to embodiments of the present disclosure.

FIGS. 9C, 9G, 9K, 90, 9S, and 9W illustrate photoluminescence decay curves according to embodiments of the present disclosure.

FIGS. 9D, 9H, 9L, 9P, 9T, and 9X illustrate g⁽²⁾ traces of individual tubes with defect-state emission at different wavelengths according to embodiments of the present disclosure.

FIG. 10A illustrates a defect-state photoluminescence spectrum according to embodiments of the present disclosure.

FIG. 10B illustrate a photoluminescence time trace according to embodiments of the present disclosure.

FIG. 10C illustrates photon antibunching properties of a DOC-wrapped Cl₂-Dz-functionalized (6,5) SWCNT under continuous wave excitation (854 nm) at room-T according to embodiments of the present disclosure.

FIG. 11 illustrates a photoluminescence emission saturation measurement of PFO-bpy wrapped (6,5) single tubes under continuous wave excitation at room-T according to embodiments of the present disclosure.

FIG. 12A illustrates a wide field image (middle, top-to-bottom, with image area of 50×50 μm) and ensemble photoluminescence spectrum (bottom) of unfunctionalized (6,5) SWCNT on a glass cover slip according to embodiments of the present disclosure.

FIG. 12B illustrates a wide field image (middle, top-to-bottom, with image area of 50×50 μm) and ensemble photoluminescence spectrum (bottom) of Cl₂-Dz functionalized (6,5) SWCNT on a glass cover slip according to embodiments of the present disclosure.

FIG. 12C illustrates a wide field image (middle, top-to-bottom, with image area of 50×50 μm) and ensemble photoluminescence spectrum (bottom) of Cl₂-Dz functionalized (6,5) SWCNT on polystyrene according to embodiments of the present disclosure.

FIG. 13A illustrates a histogram of defect-state emission linewidths for 50 individual Cl₂-Dz functionalized (6,5) SWCNT wrapped by DOC according to embodiments of the present disclosure.

FIG. 13B illustrates a histogram of defect-state emission linewidths for 50 individual Cl₂-Dz functionalized (6,5) SWCNT wrapped by PFO-bpy according to embodiments of the present disclosure.

### DETAILED DESCRIPTION

Quantum cryptography uses quantum mechanics to provide security for communications. Secure key distribution, for quantum cryptography, requires an optical source that emits a train of pulses that contain a single photon. Since measurements modify the state of a single quantum system, an eavesdropper cannot gather information about the secret key without being noticed, provided that the pulses used in transmission do not contain two or more photons.

The present disclosure provides single-wall carbon nanotubes (SWCNTs) configured to emit single photons at, in at least some examples, the telecommunication wavelength range (e.g., 1.3 μm to 1.5 μm). Moreover, SWCNTs of the present disclosure may emit single photons in at the telecommunication wavelength range while the SWCNTs are operated at room-temperature (room-T). These characteristics of SWCNTs of the present disclosure render the SWCNTs beneficial for use as optical sources for quantum communications.

Single photon emitting SWCNTs of the present disclosure may also be beneficial ultra-low noise light sources for various types of sensing, microscopy, and measurement technologies. A thin film form out of such SWCNTs could also be utilized as an active element of highly efficient light emitting diodes and lasers.

SWCNTs of the present disclosure include exciton localization at covalently-introduced sp³ defect sites. In at least some examples, the covalently-introduced sp³ defect sites may be covalently-introduced aryl sp³ defect sites. SWCNTs of the present disclosure provide room temperature (room-T) single-photon emission (SPE) with ultra-high single-photon purity (99%) and enhanced emission stability approaching the shot-noise limit.

SWCNTs of the present disclosure may be purchased commercially from, for example, Aldrich Chemical. The commercially purchased SWCNTs may then be processed to isolate a portion of the SWCNTs having a desired chirality. Example chiralities include, but are not limited to, (6,5), (7,5), (10,3), (10,5) and (11,0).

Various processes may be used to isolate SWCNTs of a desired chirality. For example, aqueous two phase separations, chromatographic approaches, and selective polymer wrapping methods may be used to isolate the SWCNT structures that demonstrate room-T telecom SPS behavior.

The isolated SWCNTs may be doped with one or more compounds to provide spa functionality. In at least some examples, an SWCNT may be doped with an aryl dopant. In at least some examples, the aryl dopant may be an aryl diazonium dopant. Example aryl diazonium dopants include, but are not limited to, 3,5-dichlorobenzenediazonium (Cl₂-Dz) and 4-methoxybenzenediazonium (MeO-Dz). Other possible sp³ dopants may be alkyl in nature. Such dopants may, in general, be introduced by a number of reaction chemistries, including (as examples and not limited to) chemistry based on diazonium, iodo, and azo functional groups.

SWCNTs of the present disclosure may be encapsulated in various materials. In at least some examples, an SWCNT may be encapsulated in a surfactant. An example surfactant is sodium deoxycholate (DOC). In at least some other examples, an SWCNT may be encapsulated in a polymer. In at least some examples, the polymer may be a polyfluorene polymer. An example polyfluorene polymer is a copolymer of 9,9-dioctylfluorenyl-2,7-diyl and bipyridine (PFO-BPy).

Various excitation wavelengths may be used to excite single-photon transmission from SWCNTs of the present disclosure. Single-photon emission may be expected when the excitation wavelength corresponds to a primary optical resonance (including excitation at the first and second exciton resonances (E11 and E22, respectively) and their related phonon sidebands) of the SWCNT being excited. For example, a (6,5) SWCNT may be excited using wavelengths near 570 nm and from about 840 nm to about 1000 nm. For further example, a (7,5) SWCNT may be excited using wavelengths near 650 nm and also from about 840 nm to about 1030 nm. In another example, a (10,3) SWCNT may be excited using wavelengths near 630 nm from about 840 nm to about 1230 nm.

In at least some examples, a single bit of information may be encoded into a single photon. In at least some other examples, multiple bits of information (e.g., up to 10 bits of information) may be encoded into a single photon.

### Tuning Defect-State Emission Wavelengths

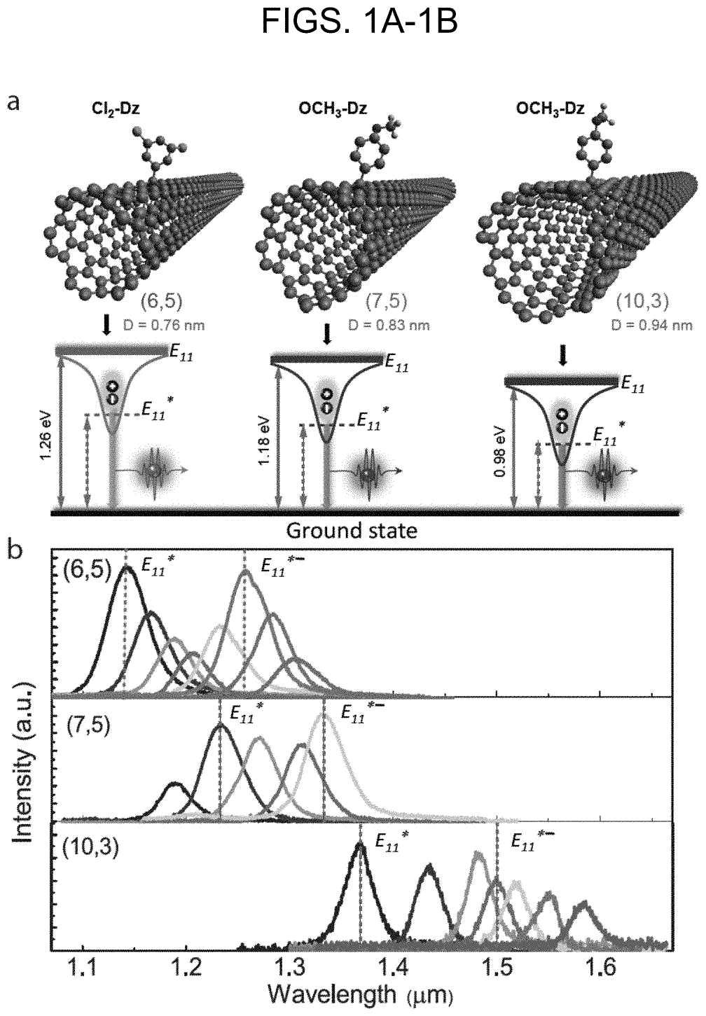

FIGS. 1A and 1B illustrate exciton localization and wavelength-tunable defect-state emission (E₁₁*) in aryl-functionalized SWCNTs of varying (n,m) chirality.

With respect to FIG. 1A, the (6,5), (7,5), and (10,3) structural series represent a SWCNT progression to larger diameter, each functionalized with a single covalently-bound aryl defect site. The lower portion of FIG. 1A illustrates a band-diagram of the aryl-functionalized (n,m) series, with standard E₁₁ exciton emission energies decreasing as diameter increases. The sp³ defects create deep-trap states (E₁₁* and E₁₁*⁻, the latter not shown) below the original E₁₁, in which optically generated excitons are trapped and can relax to the ground state to emit a single photon. The decrease in E₁₁* energies parallels that for E₁₁ as diameter increases, thus allowing defect state emission wavelengths to be tuned to telecom wavelengths. For clarity, the lower energy defect-state emission band (E₁₁*⁻) has been omitted from the energy diagram of FIG. 1A. Similar to E₁₁*, this band also decreases in energy as nanotube diameter is increased.

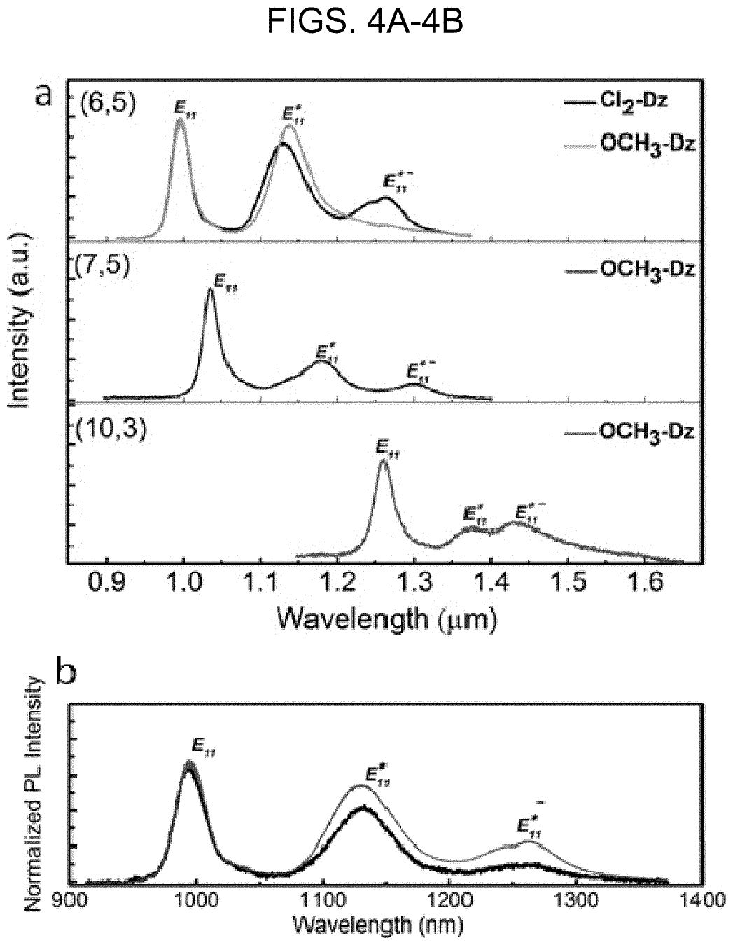

FIG. 1B illustrates example defect-state spectra obtained from (6,5) (top), (7,5) (middle), and (10,3) (bottom) structures. Each individual spectrum was obtained from a single nanotube at room-T using identical excitation and collection conditions. Variability in spectral intensities illustrates natural tube-to-tube differences. Heterogeneity in the environment experienced by individual defect sites at the single-tube level, and the possibility of multiple binding configurations on the nanotube lattice (resulting in the E₁₁* and E₁₁*⁻ emission bands illustrated in FIG. 4A), likely results in the range of emission wavelengths observed here in the single-nanotube spectra for the same dopant (see also additional Cl₂-Dz and MeO-Dz examples in FIG. 4A). Position of the two defect-state photoluminescence bands (E₁₁* and E₁₁*⁻) appearing in ensemble spectra (illustrated in FIG. 4A) are noted as reference points by dashed lines in FIG. 1B. The sum of spectra from individual nanotubes of a given bulk sample mimic the observed solution-phase ensemble spectrum for that sample (see FIG. 4B).

The variability present in SWCNT optical properties with changes in structure/(n,m) affords an effective route for obtaining a broad range of defect-state emission wavelengths. Towards this end, sp³ defect sites were introduced into SWCNT samples of three different chiralities ((6,5), (7,5), and (10,3)) through reaction of aryl diazonium dopants (3,5-dichlorobenzenediazonium (Cl₂-Dz) and 4-methoxybenzenediazonium (MeO-Dz)) with SWCNTs that are encapsulated in a sodium deoxycholate (DOC) surfactant environment or wrapped in the polyfluorene polymer, PFO-bpy (see Examples). Across this (n,m) series, SWCNT diameters range from 0.757 nm to 0.829 nm to 0.936 nm, with emission from the lowest excitonic state (E₁₁) occurring at 996 nm, 1035 nm, and 1260 nm, for the (6,5), (7,5), and (10,3) structures, respectively. Defect-state emission is strongly red-shifted (i.e., displaced toward longer wavelengths) from E₁₁, appearing typically as two emission bands in ensemble spectra (labeled as E₁₁* and E₁₁*⁻ for the deeper level of the two, illustrated in FIGS. 4A and 4B), which arise as the result of multiple possible aryl binding configurations. Both bands of the defect-state emission mirror the E₁₁ progression to lower energies as diameter increases, thus demonstrating defect-state tunability with nanotube structure as an effective route for accessing telecom-band emission wavelengths. The principles for the present disclosure's structure-based tuning of defect-state emission wavelengths are illustrated in FIG. 1A. Single-nanotube spectra obtained for several individual SWCNTs (illustrated in FIG. 1B) show the spectral window between 1100 nm and 1600 nm is spanned nearly continuously by defect-state emission from the chosen SWCNT structures, with (6,5) covering 1140 to 1300 nm, (7,5) spanning 1180 nm to 1330 nm, and (10,3) emitting from 1370 nm to 1580 nm.

While the above details the introduction of sp³ defect sites into SWCNT samples of three different chiralities ((6,5), (7,5), and (10,3)), it will be appreciated that sp³ defect sites may be introduced into SWCNTs of different chiralities. For example, sp³ defect sites may be introduced into SWCNTs having chiralities of (10,5) and (11,0), whereby defect sites of such nanotubes emit light at about 1550 nm and about 1310 nm, respectively.

### Defect-State Quantum Emission Properties

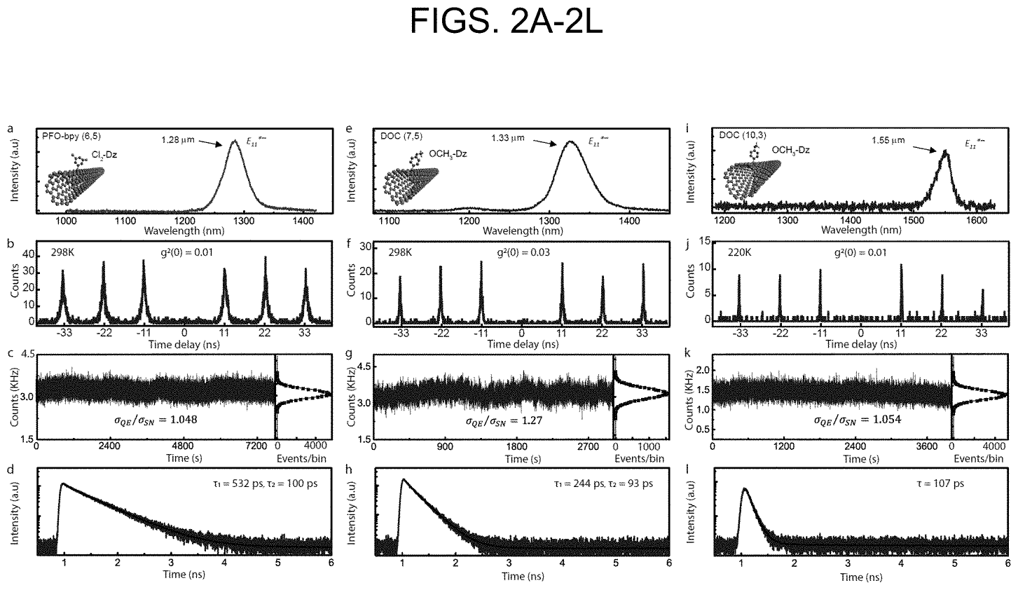

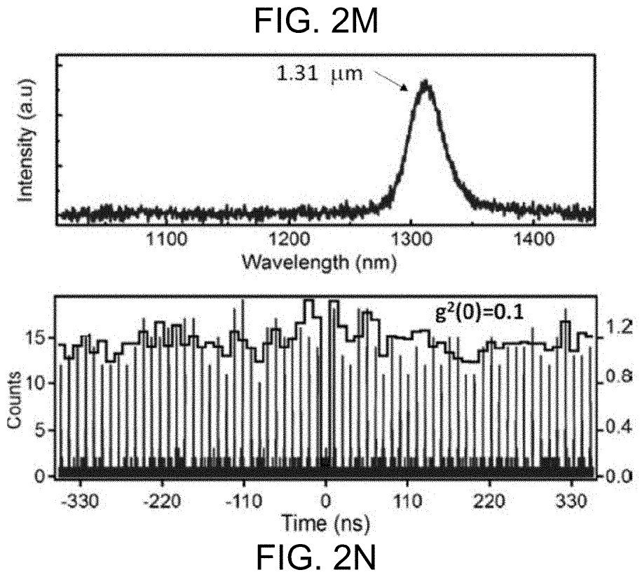

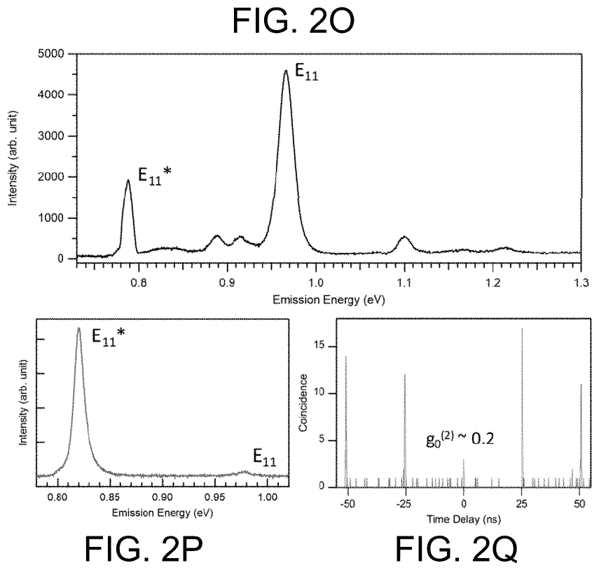

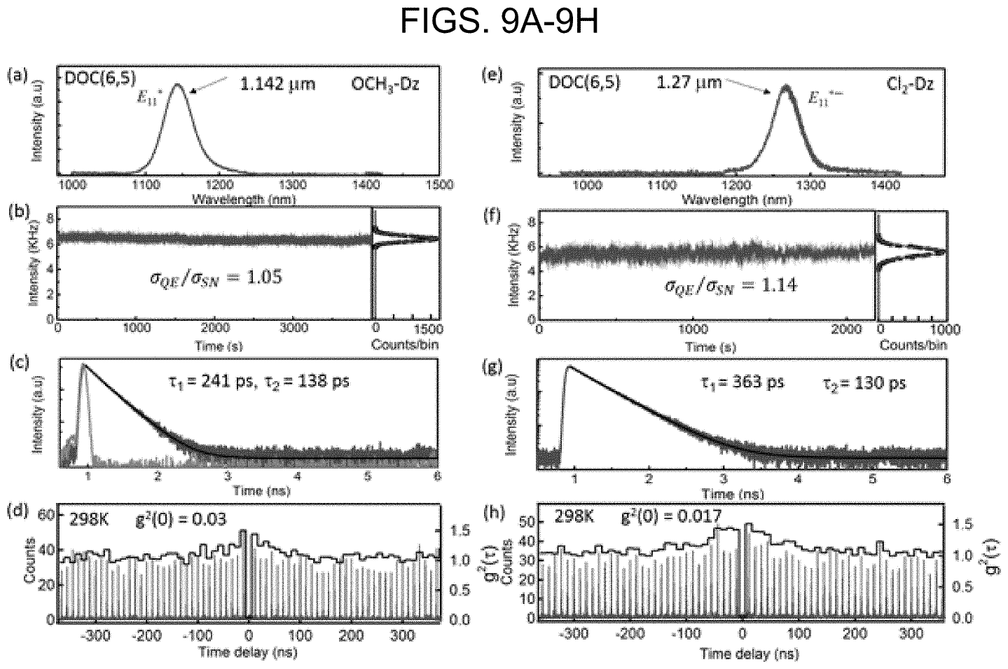

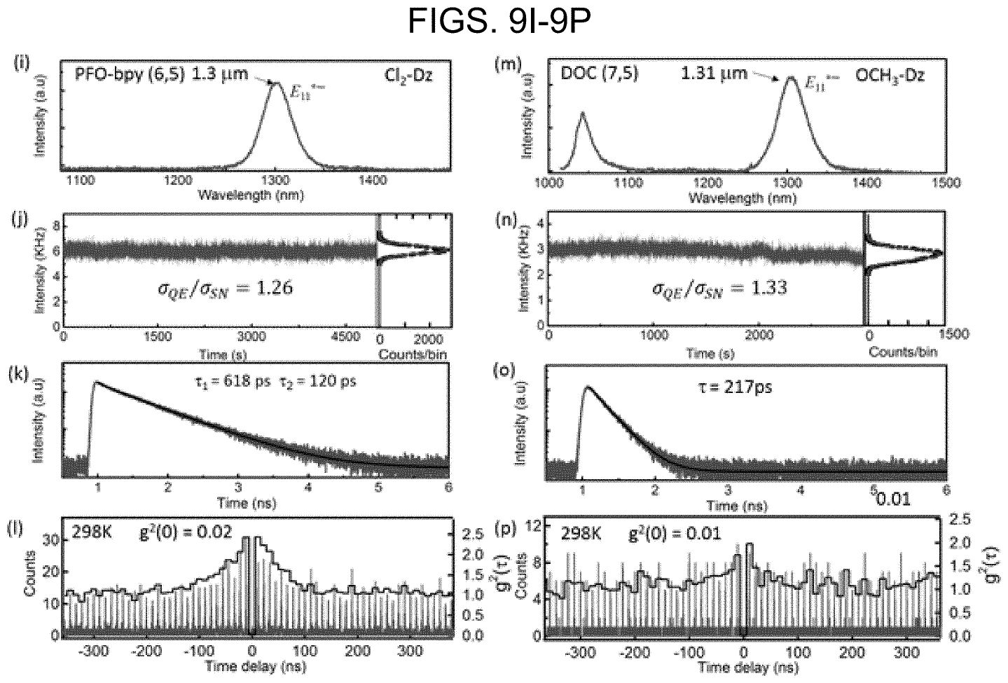

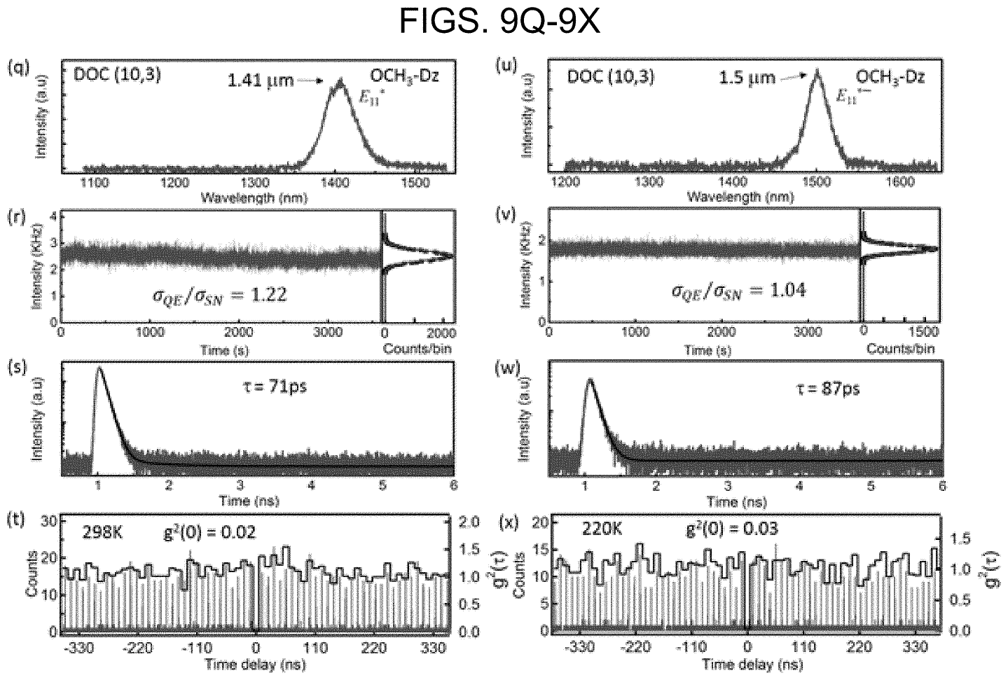

FIGS. 2A through 2L illustrate photoluminescence characteristics and photon antibunching properties of sp³ defect-state emission (E₁₁*) from aryl-functionalized (6,5), (7,5) and (10,3) SWCNTs. “Photon antibunching” is the principle that photons are more equally spaced than in a coherent laser field. Behaviors for (6,5) SWCNT in PFO-bpy (FIGS. 2A through 2D), (7,5) in DOC (FIGS. 2E through 2H), and (10,3) in DOC (FIGS. 2I through 2L) encapsulation, deposited on polystyrene-coated substrates and functionalized with Cl₂-Dz or MeO-Dz. Photoluminescence spectra are illustrated in FIGS. 2A, 2E, and 2I. Second-order photon correlation (g⁽²⁾) plots are illustrated in FIGS. 2B, 2F, and 2J. Time traces (100 ms per time point) with corresponding σ_{QE}/σ_{SN} values are illustrated in FIGS. 2C, 2G, and 2K. Photoluminescence decay curves are illustrated in FIGS. 2D, 2H, and 2L. All data in FIGS. 2A through 2L are for single tubes, with (6,5) and (7,5) data obtained at 298 K and (10,3) data obtained at 220K. Likely band origin of the defect-state emission is labeled, based on relative position with respect to the E₁₁* and E₁₁*⁻ positions shown in FIG. 1B. Time traces include count rate histograms (right inset) and are fit to a Gaussian distribution (right inset). Photoluminescence decay curves were fit to a biexponential function, with lifetime components indicated. The instrument response function, in relation to experimental decays, is shown in FIG. 9C.

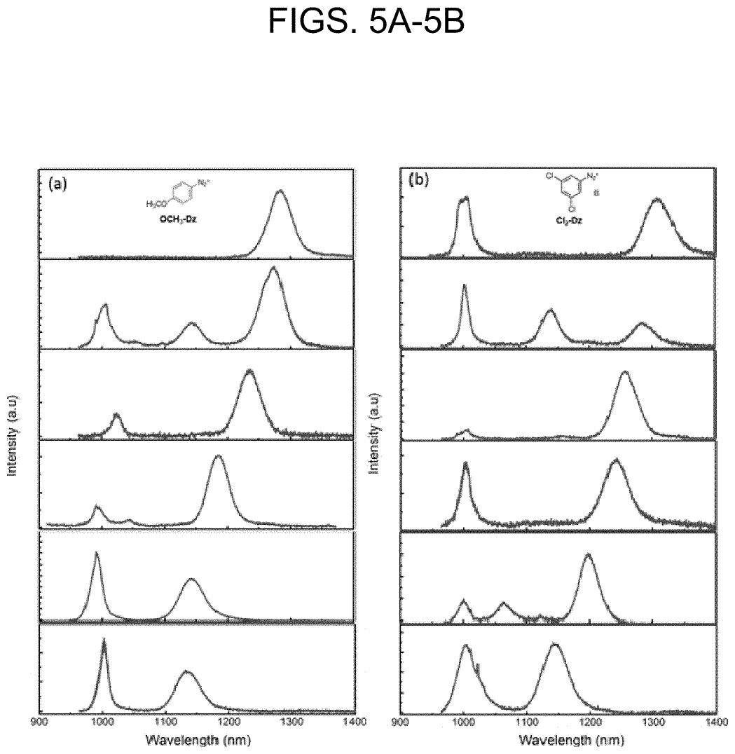

Shown in FIGS. 2A through 2L are example room-T photoluminescence behaviors relevant to SPE functionality for individual DOC and PFO-bpy coated (6,5), (7,5), and (10,3) SWCNTs that have been functionalized with Cl₂-Dz and MeO-Dz. A key characteristic of functionalized SWCNTs for promoting SPE is the ability to obtain defect-state emission from a single emitting site. In such a case, the single-nanotube photoluminescence spectrum displays only one emission peak originating from the solitary defect site, as illustrated in FIGS. 2A, 2E, and 2I. Of 60 individual tubes probed in this study, 70% displayed such single defect-state emission peaks, demonstrating that the aryl diazonium reaction chemistry provides sufficient control of functionalization to yield a high probability that a given tube will have the single or spatially well-isolated defect sites required for obtaining SPE. The resulting single photoluminescence peak is spectrally well-isolated from the SWCNT E₁₁ emission (see FIGS. 4A-4B and 5A-5B), facilitating spectral selection with simple long-pass or band-pass filters. Additional example spectra for both Cl₂-Dz and MeO-Dz are shown in Supplementary FIGS. 5A and 5B.

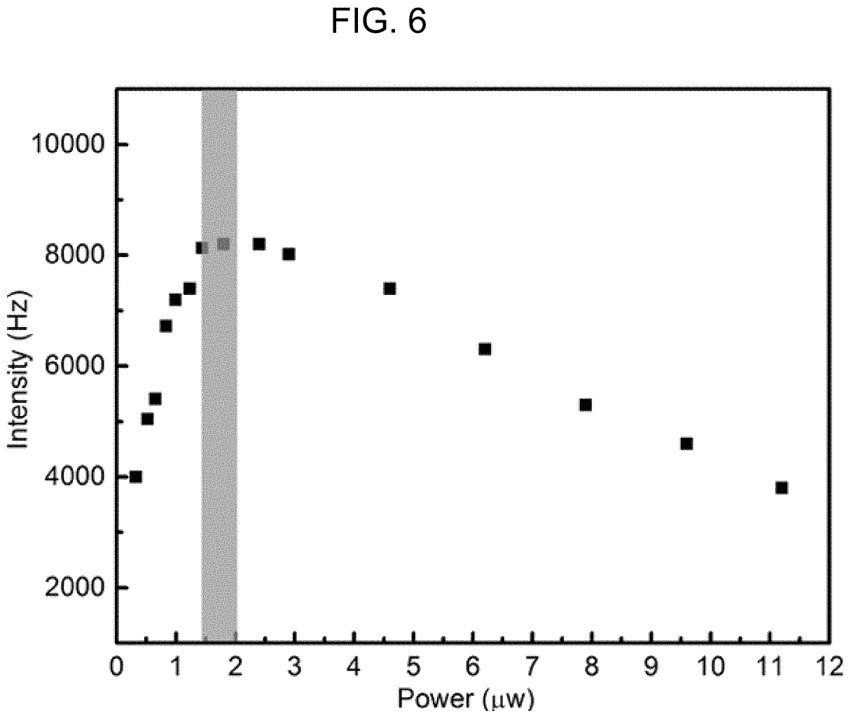

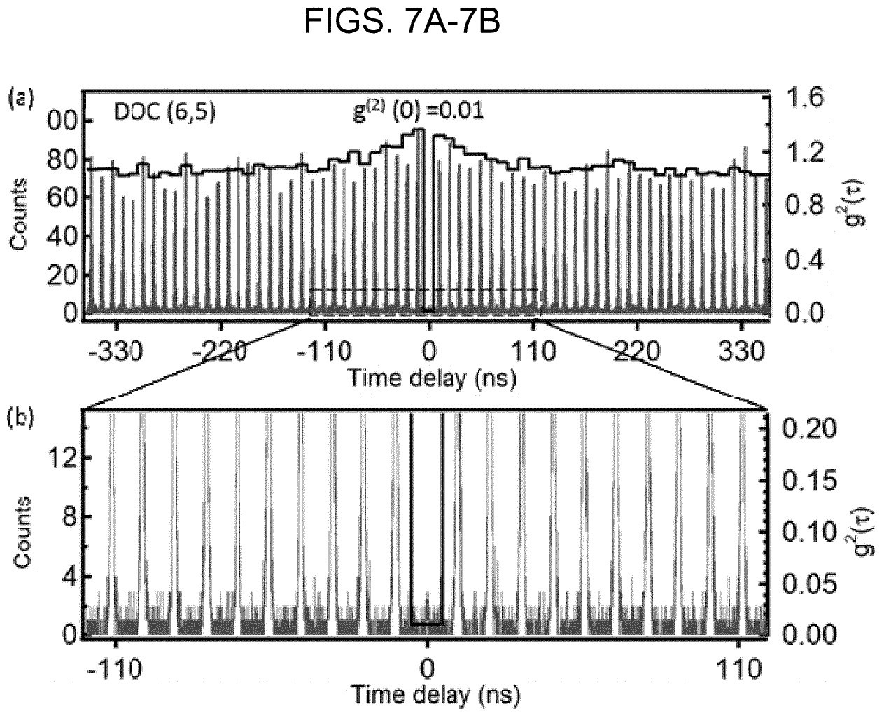

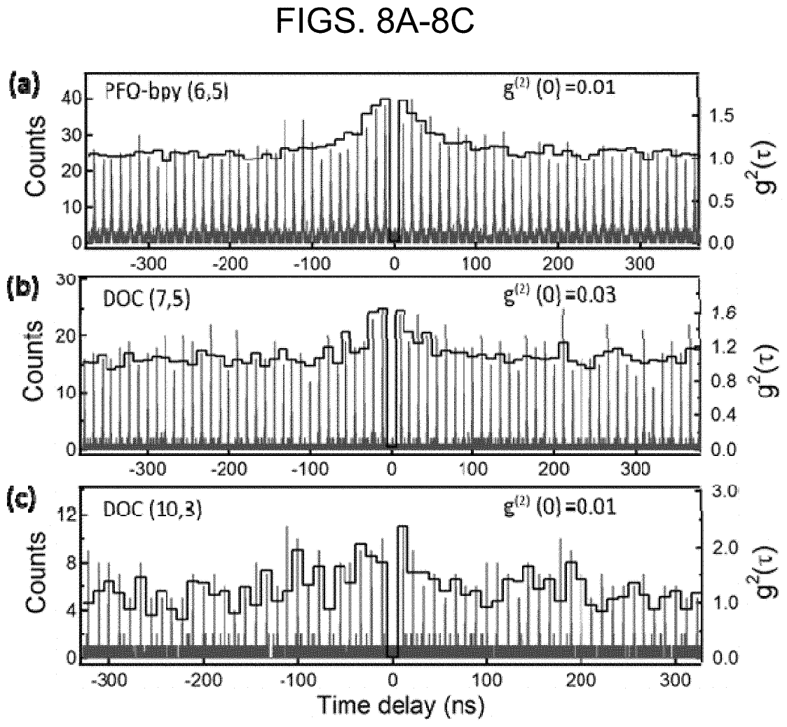

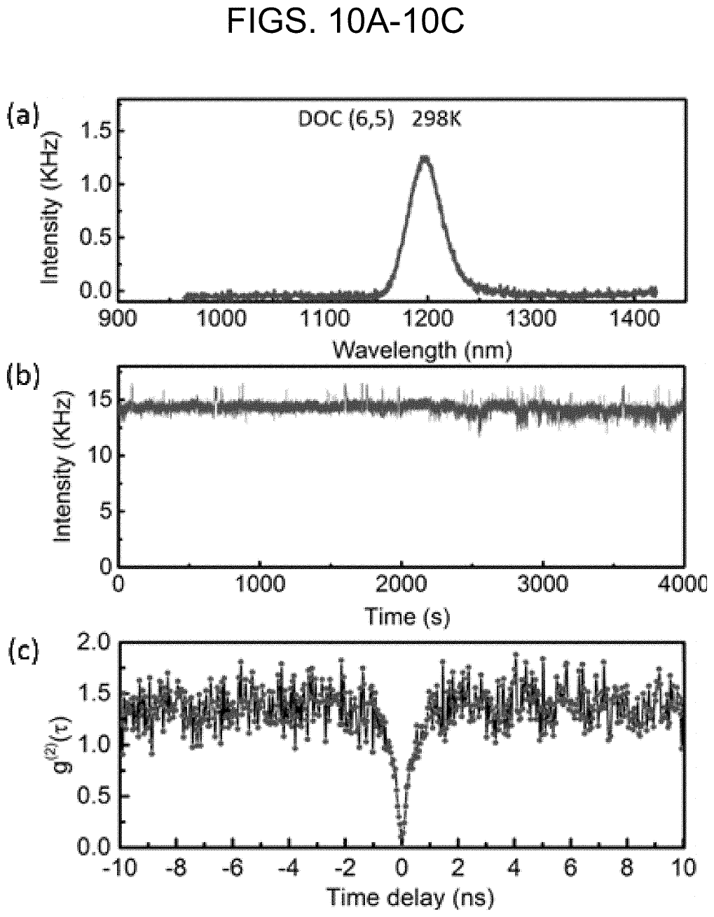

SPE is demonstrated in photon correlation measurements in which the probability of observing two-photon emission in an excitation with a single laser pulse is vanishingly small. To demonstrate this key photon antibunching signature of SPE for defect-state emission, room-T Hanbury Brown-Twiss experiments (see, e.g., the Optical Measurements section herein below) were performed to generate second order photon correlation (g⁽²⁾) traces. Example traces for defect-state emission from (6,5), (7,5), and (10,3) SWCNTs (FIGS. 2B, 2F, and 2J) show in all cases complete photon antibunching, with g⁽²⁾(0) values down to 0.01 (an experimental sensitivity limit), can be achieved at room-T over a broad wavelength range, at pump powers nearing saturation of photoluminescence intensity (see FIG. 6), and is found to be a general result across all chiralities and aryl dopants studied. The ability to easily tune SPE wavelength through choice of (n,m) is thus demonstrated, with such behavior observed for emission originating in either E₁₁* or E₁₁*⁻ photoluminescence bands. See FIGS. 7A-7B and 8A-8C for details of g⁽²⁾(0) determination, and see FIGS. 9A-9X for additional g⁽²⁾ trace examples. A similarly high degree of photon antibunching (g⁽²⁾(0)˜0) is also attained under continuous wave laser excitation (see FIGS. 10A through 10C).

The single-photon purity (1−g⁽²⁾(0)) attained with the aryl dopants (0.99 for g⁽²⁾(0) of 0.01 shown in FIG. 2) is superior to that found at room-T for oxygen functionalized SWCNT (0.68). Obtaining this high room-T single-photon purity is beneficial for applications such as quantum key distribution, logic gates, and memory. Of the wide range of single-photon emitters available, the only other materials meeting this level of single-photon purity are InAs/InP quantum dots (QDs), but only for operation at cryogenic (liquid He) T. Single-photon purity for these QDs and for recently discovered defect states of 2D materials also deteriorates rapidly at high pump powers, mainly due to a rise of emission contribution from higher energy excited states and the low energy tails of band-edge excitons. In contrast, the herein disclosed dopant states are well-isolated from the tail of band-edge emission, and as true two-level systems, are incapable of supporting higher excited-state emission. They are thus able to simultaneously support high single-photon purities of 0.99 at room-T and high pump powers, a combination of performance metrics superior to that demonstrated in diamond NV centers to date (showing single-photon purities of 0.7-0.9).

A benefit of the herein disclosed results is the achievement of room-T SPE at the telecom O and C bands. SPE from functionalized (7,5) SWCNT reliably and most directly accesses the telecom O band (centred at 1300 nm), of interest due to low fiber dispersion in this region. More notably, the present disclosure demonstrates that emission from the E₁₁*⁻ band of the (10,3) structure effectively provides high-quality SPE at the center of the most commonly used low-loss C band (1550 nm). While InAs/InP QDs display exceptional SPE characteristics at both telecom bands, their performance can only be achieved at liquid He temperatures.

The results shown in FIGS. 2I through 2L for the (10,3) nanotube were obtained at 220K. Low count rates for the (10,3) nanotube at room-T renders the second order photon correlation measurements not possible, partly due to the off-resonance excitation (˜870 nm) and the low sensitivity of the detector beyond ˜1.5 μm. As found for oxygen-doped SWCNT, however, moderately-reduced temperatures (220K in this case) will increase count rates, in part due to reduction of thermal detrapping of excitons at the defect sites. Such a modest reduction in temperature in order to make the g⁽²⁾ measurement at 1.55 μM suggests that the (10,3) SWCNTs are active single-photon emitters at room-T, while 220K is easily achievable with thermo-electric cooling. As further evidence that room-T SPE from the (10,3) chirality occurs, complete antibunching (g⁽²⁾(0)=0.01) at room-T was observed for (10,3) emitting at 1.41 μm (see FIGS. 9Q through 9T).

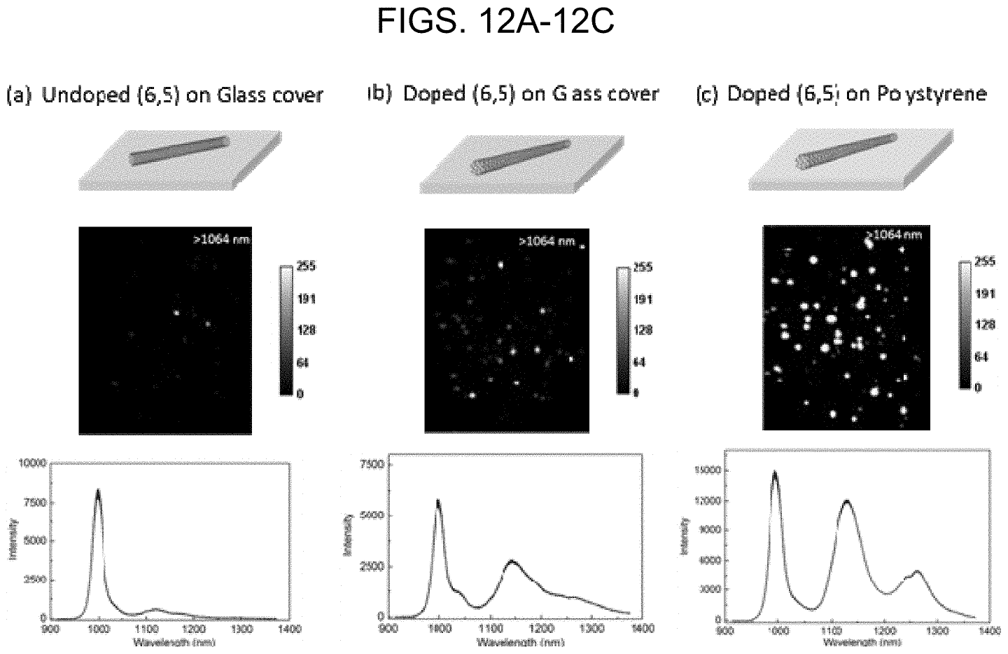

The sp³ defect states also display exceptional photoluminescence stability and high emission efficiency. Time traces of the aryl-defect emission at room-T (see FIGS. 2C, 2G, and 2K) show no evidence of blinking over periods of 2 hours for each of the chiralities. Histograms of photoluminescence count rates collected over this time period (FIGS. 2C, 2G, and 2K) and simulated Gaussian distributions of shot-noise reveal that the count rate fluctuations are at the shot-noise limit. Quantifying the deviation of count rate distribution for the quantum emitter (QE) from the shot noise (SN) limit as σ_{QE}/σ_{SN}={square root over ( [symbol] ² [symbol] − [symbol] n [symbol] ²)/ [symbol] n [symbol] )}, where n equals the number of photoluminescence counts per 100 ms time bin, gives values of 1.048 to 1.27 for the data of FIGS. 2A through 2L (σ_{QE}/σ_{SN}=1 at the shot-noise limit). While single photon emitters under ideal conditions can exhibit below shot-noise fluctuations, due to relatively low quantum yield and detection efficiency one may expect to achieve shot-noise limited fluctuation for blinking and bleaching free emitters. Blinking refers to the phenomenon of random switching between on (bright) and off (dark) states of an emitter under continuous excitation. Bleaching, or photobleaching, refers to the photochemical alteration of a molecule such that is permanently is unable to fluoresce. Nonetheless, the results show dramatic improvement over the photoluminescence instability found with oxygen doping (with room-T σ_{QE}/σ_{SN} values of 3.5 or greater). The improvement is a consequence of both the aryl functionality (predicted by DFT calculations to provide enhanced environmental stability) and benefit of the nonpolar environment (the polystyrene layer) in which the emitters are incorporated (see FIGS. 12A through 12C).

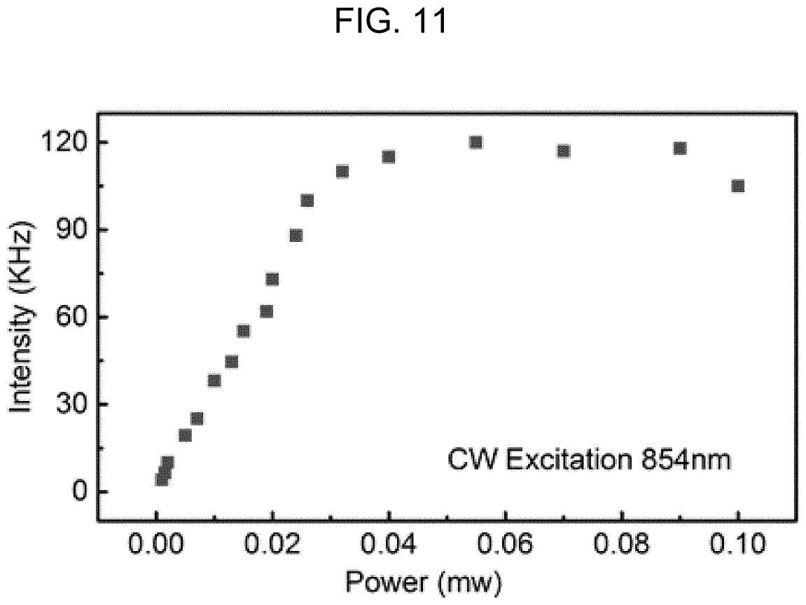

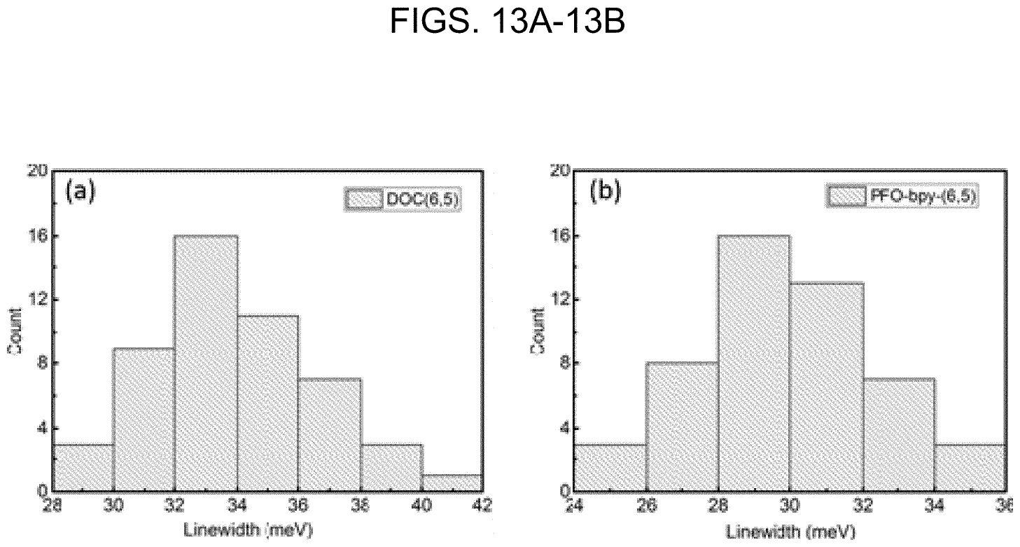

Beyond their photoluminescence stability, the defect-states also display high emission efficiency. For (6,5) tubes, observed defect-state emission rates (FIG. 2C and FIGS. 9A-9X) range from 4-6 kHz under 90 MHz pulsed excitation, a factor of 2-3 higher than typically observed for oxygen-doped SWCNTs, likely arising from the higher quantum yields expected for aryl functionalization. Count rates up to 120 kHz are observed under continuous wave excitation (see FIG. 11), despite a low combined photon collection and detection efficiency (0.05%) for the near-IR emission of the defect states. Direct coupling of emission to waveguides (with demonstrated coupling efficiency of 75%), paired with higher efficiency detectors, can make 10-100 MHz count rates feasible. The defect-state emission rates are thus comparable to the high rates obtained from diamond color centres and InAs quantum dots. Correcting for collection and detection efficiency, one may estimate a single-photon emission quantum efficiency of ˜12% for PFO-bpy wrapped (6,5) tubes at ˜1.3 μm. This value compares favorably to reports for diamond NV centres (70%), particularly when one considers the <30 meV emission bandwidth of SWCNT defect states (see FIGS. 13A and 13B) in comparison to the room-T emission of the NV centres being primarily distributed over a 300 meV wide phonon side-band, with only 4% coupled to the zero phonon line. A “phonon” refers to a collective excitation in a periodic, elastic arrangement of atoms or molecules in condensed matter (e.g., solids and some liquids).

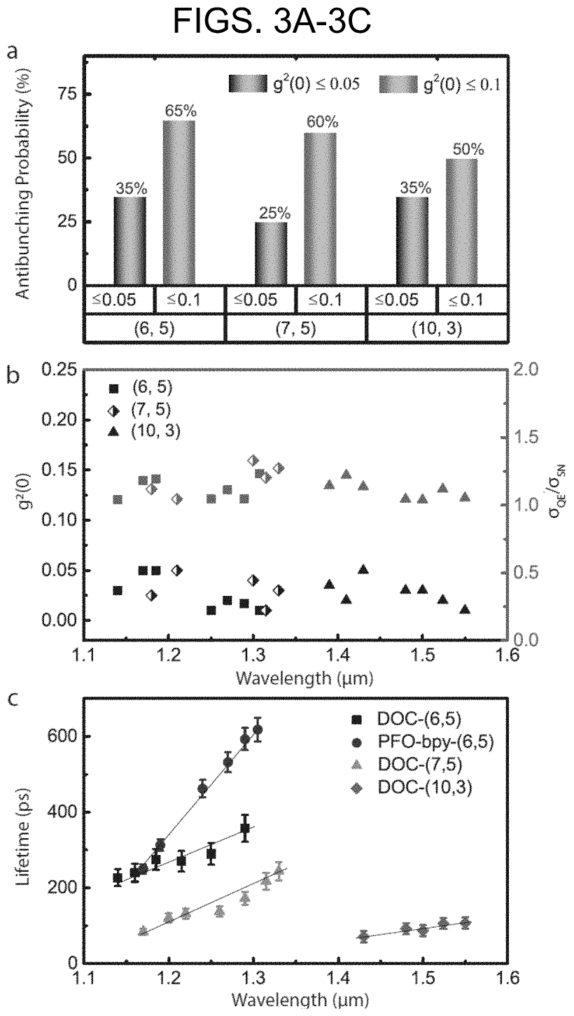

In addition to the g⁽²⁾ and time trace data, photoluminescence decays of the defect states were also measured. The decays were biexponential, with lifetime components of 100-600 ps (see FIGS. 2D, 2H, 2L, and FIGS. 9A-9X), significantly longer than the 10-50 ps decays typically observed for undoped E₁₁ emission. The extended decay time of the defect photoluminescence is a consequence of exciton localization at the defect sites, which is a primary requirement for observing SPE in SWCNTs. Inspection of the diameter dependence of the photoluminescence decay times shows a clear trend: as diameters increase, photoluminescence lifetimes are found to decrease (FIGS. 2D, 2H, 2L, and FIGS. 3A-3C), in agreement with solution-phase studies that find the associated multiphonon decay (MPD) rates increase as the energy gap to the ground state is reduced.

FIGS. 2M and 2N illustrate photoluminescence characteristics and photon antibunching properties of sp³ defect-state emission (E₁₁*) from aryl-functionalized (11,0) SWCNTs. Specifically, FIG. 2M is a photoluminescence spectrum of a (11,0) SWCNT functionalized with 4-methoxybenzen as a sp³ defect. The (11,0) SWCNT had a diameter of 0.873 nm. Photoluminescence at 1310 nm demonstrates emission in the telecom O band. FIG. 2N is a second order photon correlation (g²(t)) plot for the emission shown in FIG. 2M. The plot of FIG. 2N demonstrates antibunching and thus single photon emission behavior from the (11,0) SWCNT structure.

FIGS. 2O through 2Q illustrate photoluminescence characteristics and photon antibunching properties of sp³ defect-state emission (E₁₁*) from aryl-functionalized (10,5) SWCNTs. FIG. 2O is a room-T ensemble photoluminescence spectrum of (10,5) nanotube functionalized using iodoaniline. The (10,5) SWCNT had a diameter of 1.05 nm. Normal exciton (E₁₁) and sp³ defect-state (E₁₁*) emission peaks are shown at 0.965 eV and 0.79 eV (1285 nm and 1570 nm), respectively. Thus, a (10,5) SWCNT may emit single photons at about 1550 nm. FIG. 2P is a room-T single-tube photoluminescence spectrum of a single (10,5) nanotube functionalized using iodoaniline. A defect-state (E₁₁*) emission peak is shown at 0.82 eV (1512 nm). FIG. 2Q is a room-T second order photon correlation plot for the (10,5) nanotube sampled in FIG. 2P. Strong antibunching was demonstrated with a g²(t=0) value of 0.2.

### Trends in Quantum Emission Behaviors

It is worth commenting on global trends observed in photon statistics and dynamics across all nanotubes disclosed herein. First, it is important to evaluate the likelihood of observing antibunching behavior in any chosen nanotube. From the pool of individual nanotubes that display a single defect-state emission peak, it was found that the probability of observing g²(0)<0.05 is above 25-35% for all three chiralities, and rises to greater than 50% for observing g²(0)<0.1 (FIG. 3A). This rate is much higher than that (˜10% for g²(0)<0.5) found on oxygen functionalized (6,5) tubes, in part due to the high efficiency noted earlier for generating solitary defect sites through controlled aryl functionalization. Furthermore, g²(0)<0.05 paired with σ_{QE}/σ_{SN} values of −1 are consistently observed in the spectral window from 1.14 μm to 1.55 μm, with single photon purity of 99% (g²(0)=0.01) being regularly achieved (FIG. 3B). These results indicate that one can maintain functional properties for high quality quantum emission over the full range of SWCNT structures that can be chosen for targeting select behaviors.

Inspection of photoluminescence lifetime data (FIG. 3C) shows two somewhat opposing trends in the defect-state emission dynamics. As noted above, as nanotube diameters increase, and emission energies generally decrease, a parallel decrease in photoluminescence lifetime is observed, consistent with an MPD mechanism for nonradiative exciton relaxation of the defect states. In seemingly contradictory behavior, however, for a given chirality, as emission wavelength increases, so does the photoluminescence lifetime. This behavior may be due to the specifics of the electronic structure associated with a particular defect site. Of relevance is the splitting of the aryl defect-state emission into relatively high (E)₁₁*) and low (E₁₁*⁻) energy sub-bands. The larger lifetime found for the reddest states suggests that, within a MPD picture of relaxation, exciton-phonon coupling might be reduced for the deepest trap states relative to the higher energy component. Moreover, this finding suggests that synthetic control over spectral behavior may provide a route to tune emission energies further, while also enhancing photoluminescence lifetimes and emission count rates. Modulating photoluminescence behavior may also be accomplished via choice of solution processing and suspension methods. In particular, photoluminescence lifetimes are generally found to be significantly longer for PFO-bpy-wrapped SWCNTs (exceeding 600 ps) than for those in the DOC environment (FIG. 3C), possibly resulting from a more stable wrapping found for PFO-bpy in comparison to surfactant (e.g., DOC) coatings that have more dynamic surface structures. Absence of endohedral water in the PFO-bpy structures, but likely to occur as a consequence of the aqueous processing of the DOC-wrapped SWCNTs, may also be a factor in the lifetime differences. The large differences introduced by SWCNT wrapping type and processing indicate modulation of the surface and internal environments can be an effective route to tune the defect-state dynamics. Even so, in general both PFO-bpy and DOC environments promote excellent SPE characteristics (FIGS. 2A-2L) and enable introduction of such functionality through complementary approaches that are compatible with a variety of matrices and SWCNT processing. Defect introduction into PFO-bpy-wrapped SWCNTs is particularly significant in that such nanotubes are a starting point for integration into a broad range of electronic and electro-optic devices.

FIG. 3A illustrates probabilities of observing single photon emission with g²(0)≤0.1 and ≤0.05 for chiralities (6,5), (7,5) and (10,3), each based on a total number of thirty individual nanotubes, with each displaying a single defect-state emission peak. FIG. 3B illustrates example g²(0) values (lower)<0.05 observed at different wavelength and corresponding σ_{QE}/σ_{SN} values (top) evaluated for (6,5), (7,5), and (10,3) SWCNTs. Values of 0.01 are noise-limited. FIG. 3C illustrates observed average photoluminescence lifetimes for four sample types observed across the photoluminescence wavelength range. The data are combined results for both Cl₂-Dz and MeO-Dz functionalization and span both E₁₁* and E₁₁*⁻ emission bands. Error bars were obtained as fitting errors from the biexponential fits of the photoluminescence decay curves.

### EXAMPLES

### SWCNT Chirality Enrichment

PFO-bpy wrapped (6,5) SWCNT were isolated in toluene suspensions. Chirality-enriched (6,5) and (7,5) SWCNTs suspended in 1% sodium deoxycholate (DOC) were prepared as follows: Initial 1 mg/mL suspensions of CoMoCat SG65i starting materials were prepared as aqueous 1% sodium deoxycholate (DOC) suspensions using 20 min. of tip sonication (using a Sonics “Vibracell” model CV18, ¼″ diameter probehead), at a power of 0.9 W/mL, while sample was cooled in an ice bath. Separations were performed using a two-step aqueous two-phase extraction process. For samples highly enriched in single-chirality (10,3) SWCNT, a column chromatography method was used. Briefly, 100 mg of HiPco SWCNTs (R1831, 1.0±0.3 nm in diameter, NanoIntegris, Inc.) was dispersed in 100 ml of an aqueous solution containing 1.0% sodium dodecyl sulfate (SDS, 97%, Tokyo Chemical Industry) and 0.5% sodium cholate (SC, 98%, Tokyo Chemical Industry) for 3 h using a tip-type ultrasonic homogenizer (Sonifier 250D, Branson) while sample was immersed in a cold-water bath, followed by ultracentrifugation at 210,000 g for 2 h using an angle rotor (S50A, Hitachi Koki). The upper 80% of the supernate was collected for separation. For the separation, conventional chromatography system (AKTA explorer 10S, GE Healthcare) installed in a chamber maintained at 18-20° C. was used. About 80 ml of the SWCNT solution was loaded onto a column (Hiscale 50/20, GE Healthcare) filled with 430 ml of gel beads (Sephacryl S-200 HR, GE Healthcare). After elution of unbound SWCNTs with an aqueous solution of SDS (1.0%)+SC (0.5%), the adsorbed SWCNTs were eluted and collected through stepwise elution chromatography with DOC (96%, Wako Pure Chemical Industries) where the DOC concentration was increased from 0.12 to 0.18% in 0.01% steps for fixed concentrations of SDS (1.0%)+SC (0.5%). Single-chirality (10,3) SWCNTs were eluted at a concentration of SDS (1.0%)+SC (0.5%)+DOC (0.16%).

### SWCNT Functionalization

Two types of aryl functionalization processes were used to dope chirality-enriched SWCNTs. The first is a solution doping method, in which the (6,5) and (7,5) chirality-enriched SWCNT samples are first exchanged into 1% (w/v) sodium dodecyl sulfate (SDS) by pressure filtration through a 100 kDa membrane, using 1% SDS as eluate, while (10,3) samples were used as originally isolated. For 3,5-diclorobenzene diazonium (4-methoxybenzene diazonium), 50 μL of doping solution with an aryl diazonium salt concentration of 0.01(0.1) mg/mL was added to 1 mL of SWCNT solution for which an optical density of 0.1 is obtained at the E₁₁ absorption peak. The reaction was monitored via photoluminescence spectroscopy, and the progress was stopped at the desired extent by exchanging the samples into 1% (w/v) DOC by pressure filtration through a 100 kDa cellulose membrane. Typical reaction times for (6,5) and (7,5) samples were 10 minutes. Towards the goal of introducing single isolated defect sites per individual nanotube, this process results in significantly lower levels of functionalization. This difference, paired with a difference in surfactant environment resulting from introduction of DOC, can result in differences in observed ensemble-level photoluminescence spectra (see, for example, FIG. 4A). For (10,3) samples, reactions only proceeded when enhanced by lamp illumination, with reactions still requiring 4 hours to achieve a sufficient level of functionalization to observe the sp³ defect-state photoluminescence. A second functionalization procedure was used for doping of (6,5) nanotubes wrapped in PFO-bpy (poly[(9,9-dioctylfluorenyl-2,7-diyl)-alt-co-(6,6′)-{2,2′-bipyridine})]). Following deposition onto sample substrates of PFO-bpy wrapped SWCNT from toluene solutions, a dip-doping process was used in which the functionalization reaction occurs on the solid substrate. The substrate containing the PFO-bpy wrapped SWCNT was exposed to a droplet of the aqueous solution of aryl diazonium salt, or by immersing the substrate into the salt solution for 3-5 minutes. The doping process was stopped by putting the substrate into 1% (w/v) DOC for another 3 minutes. Only dip-doping with 3,5-diclorobenzene diazonium (0.7 mg/mL in nano-pure water) was found to be successful with the PFO-bpy wrapped (6,5) SWCNTs.

### Substrate and Sample Preparation

Functionalized SWCNTs were spin-coated onto glass cover slips over-coated with a 300 nm Au layer (electron-beam evaporation) and followed by spin-coating of a 160 nm polystyrene layer. The Au layer was added to enhance the photon collection efficiency, while the polystyrene layer provides a low-polarity, charge-free environment to suppress photoluminescence blinking and quenching. SWCNT suspensions were drop-dried onto measurement substrates at a nanotube density of ˜1 nanotube/4 μm², sufficiently low to ensure single isolated SWCNTs are probed with an excitation laser at any given sample position.

### Optical Measurements

A home-built microscope-photoluminescence system was used to perform all spectroscopy experiments. Doped SWCNT samples on glass covers coated by Au and polystyrene were placed on a motorized stage. An infrared objective (Olympus) with NA=0.65×50 magnification was used to confocally excite and collect the photoluminescence signal. Excitation source is a pulsed laser (150 fs, 90 MHz) operating at excitation powers of a few μW. Excitation wavelengths of 854 (870) nm match the phonon-side band absorption for (6,5) ((7,5)) chiralities. Off-resonant excitation at 870 nm (limited by wavelength tuning range) was also used for (10,3) SWCNTs. Photoluminescence images and spectra were taken with a two-dimensional InGaAs array camera and one-dimensional InGaAs linear array detector, respectively. For time-correlated single photon counting and Hanbury Brown-Twiss experiments, an appropriate long-pass filter was inserted into the light collection path to reject E₁₁ emission, while passing longer wavelength emission from the defect states, which was coupled into an optical fiber and then a 1:1 optical fiber beamsplitter was used to split the signal into the two channels of a super-conducting nanowire single-photon detector (Single Quantum Eos 210). Photoluminescence time traces, photoluminescence decay curves, and g⁽²⁾ functions were obtained from macro- and micro-times of photon detection events recorded using HydraHarp 400 time-correlated single photon-counting electronics. For photon-correlation experiments of (6,5) SWCNTs under continuous wave excitation, a wavelength tunable continuous wave laser with excitation wavelength of 854 nm was used, with an excitation power of ˜5 μW. Measurement was done with the T2 mode of a HydraHarp 400 and the data was analysed by Sympho Time 64 software from PicoQuant.

While it has been described that 870 nm femtosecond laser pulses at 90 MHz may be used as excitation for producing single photons, one skilled in the art will appreciate that other possible excitation wavelengths and repetition rates are possible. Excitation can be performed using a wide range of excitation wavelengths, including excitation at, for example, E₁₁ and E₂₂ exciton resonances and associated phonon sidebands particular to any specific tube structure used for the single photon generation. While excitation at such exciton and phonon-sideband resonances provide the best emission count rates, general excitation at wavelengths shorter than the E₁₁ resonance will excite photoluminescence from the tubes.

Moreover, while the present disclosure describes 3 specific nanotube structures (i.e., (6,5), (7,5), and (10,3)), the teachings of the present disclosure are not limited thereto. The teachings of the present disclosure may be applied to other nanotube structures that have sp³ functionalization.

FIG. 4A illustrates room-T ensemble photoluminescence spectra of Cl₂-Dz and MeO-Dz functionalized (6,5) (top), (7,5) (middle), and (10,3) (bottom) SWCNTs in aqueous 1% DOC suspensions. Standard exciton (E₁₁) and defect-state (E₁₁* and E₁₁⁻) emission peaks are labeled.

FIG. 4B illustrates statistics of photoluminescence spectra for individual nanotubes in comparison to ensemble spectrum. An average spectrum obtained as the sum of room-T photoluminescence spectra recorded from 30 individual 3,5-dichlorobenzene-functionalized (6,5) SWCNTs is compared to the solution ensemble photoluminescence spectrum for the source sample.

### Synthetic Tunability of Aryl-Diazonium Dopants: Spectra and Reactivity

Beyond the enhanced photoluminescence stability and reaction control afforded by use of aryl diazonium functionalization, these agents also provide synthetic tunability over reactivity and defect-state emission wavelengths. In addition to incorporation of 3,5-dichlorobenzenediazonium (Cl₂-Dz) at defect sites, 4-methoxybenzendiazonium (MeO-Dz) was used as a dopant.

FIG. 5A is representative of room-T photoluminescence spectra of a single (6,5) SWCNT functionalized by MeO-Dz. FIG. 5B is representative of room-T photoluminescence spectra of a single (6,5) SWCNT functionalized by Cl₂-Dz. All spectra are from DOC-wrapped SWCNT. Emission peaks appearing near 1000 nm are due to (6,5) E₁₁ exciton emission, while longer wavelengths originate from the aryl sp³ defect states.

The electron withdrawing nature of Cl₂-Dz provides greater reactivity in comparison to MeO-Dz. The increased reactivity may be an important factor in the dip-doping of the PFO-bpy-wrapped nanotubes, in that MeO-Dz may be insufficiently reactive to functionalize the PFO-bpy-wrapped nanotubes. Furthermore, by choosing Cl₂-Dz as a dopant, SPE crossing 1.3 μm is successfully realized on PFO-bpy-wrapped (6,5) nanotubes, which cannot be achieved with MeO-Dz or by simple oxygen doping. In ensemble level spectra, variation of the aryl group functionality can tune defect-state emission wavelengths over 10 s of meV. In addition to the primary defect-state emission feature (E₁₁*) occurring ˜140-160 meV to lower energy from E₁₁, an additional feature occurring 200-300 meV lower can occur (E₁₁*⁻). This feature can thus extend the wavelength range over which a given dopant introduces emitting states. The SPE behavior of MeO-Dz functionalized nanotubes are found to be similar to those of the Cl₂-Dz examples, demonstrating the generality of this type of functionalization for obtaining SPE.

Shown in FIGS. 5A and 5B are typical photoluminescence spectra of individual (6,5) SWCNT functionalized by these two aryl diazonium species. 70% of the photoluminescence spectra (out of 60 nanotubes checked for each dopant) show single defect-state emission peaks. SPE is observed only for individual SWCNT displaying a single defect-state emission peak. The peak position and intensity can vary from tube-to-tube. While E₁₁ exciton emission is centered at 1000 nm, the defect-state peaks are red-shifted and distributed over a broad wavelength range. The reddest extension of the wavelength range is different for the two dopants. For MeO-Dz functionalized (6,5) SWCNT, the longest wavelength observed was around 1290 nm, while it is ˜1310 nm for Cl₂-Dz functionalized (6,5) SWCNT.

FIG. 6. Illustrates defect-state photoluminescence intensity saturation behavior. Single-tube defect-state emission intensity is shown as a function of pump power for an example individual (6,5) SWCNT emitting at 1240 nm. Data is for pulsed excitation at 854 nm. Photoluminescence saturation onset occurs at ˜1.5 μW in this case. The shaded region highlights the typical incident power range over which g⁽²⁾ and intensity time-trace data is obtained (1.5-2 μW).

### The Determination of g²(0)

g⁽²⁾(0) values were determined as the ratio of the center-peak area normalized to the side peaks at times >330 ns, as shown in FIGS. 7A and 7B. Performing this ratio at long times avoids under-evaluation of g⁽²⁾(0) when taking the ratio at short times at which minor photon bunching is found for early-time side peaks, which decays to an average uniform value at long times (>330 ns). FIGS. 8A through 8C illustrate full g⁽²⁾ traces of FIGS. 2B, 2F, and 2J, respectively.

As suggested by single-tube photoluminescence studies at cryogenic temperatures, the short-time bunching signatures demonstrated in FIGS. 7A-7B and 8A-8C likely arise from blinking and spectral wandering that occur on short timescales. Such behavior may arise from local charging induced by perturbation of the electrostatic environment caused by the aryl defects. While this effect is minimized for the aryl defects in comparison to that introduced by oxygen functionalization, it is still present to some degree. The decay time of the bunching behavior reflects the timescale of the photoluminescence fluctuations: tens of nanoseconds.

### Additional Optical Data Sets at Different Defect-State Emission Wavelengths Under Pulsed Excitation

Photon-correlation measurements were performed in the wavelength range from 1.14 to 1.55 μm on three species of SWCNTs ((6,5), (7,5), (10,3)), using Cl₂-Dz and MeO-Dz as dopants, at room-T and ambient condition. For (10,3) samples, because of the low combined collection and detection efficiency of the microscope and detector system at wavelengths around 1.5 μm, some g⁽²⁾(0) measurements were done at 220K (for emission wavelengths of 1.43-1.55 μm) to get sufficiently high signal for these longest emission wavelengths. At both room-T and 220K, high single-photon purities were obtained, as shown in FIGS. 9T and 9X.

FIGS. 9A, 9E, 9I, 9M, 9Q, and 9U illustrate photoluminescence spectra. Likely band origin of the defect-state emission is labeled, based on relative position with respect to the E₁₁* and E₁₁*⁻ positions shown in FIG. 4A. FIGS. 9B, 9F, 9J, 9N, 9R, and 9V illustrate photoluminescence time traces with corresponding σ_{QE}/σ_{SN} values. FIGS. 9C, 9G, 9K, 90, 9S, and 9W illustrate photoluminescence decay curves. FIGS. 9D, 9H, 9L, 9P, 9T, and 9X illustrate g⁽²⁾ traces of individual tubes with defect-state emission at different wavelength. All the time traces were fitted with Gaussian functions. All the lifetime curves were fitted with double exponential functions in a reconvolution mode and the values of lifetime are highlighted. Instrument response function is also shown in FIG. 9C (gray curve).

### g⁽²⁾(t) Measurement Under Continuous Wave Excitation

Photon correlation measurements were performed on Cl₂-Dz-functionalized (6,5) SWCNT with continuous wave excitation at 5 μW of incident power. Under continuous wave excitation, the emission rate is normally larger than that under pulsed excitation at comparable excitation power. As shown in FIGS. 10A through 10C, stable and high emission rates (˜15 kHz) and complete photon-antibunching (g²)(0)˜0) are obtained at room-T.

### Data Collection Efficiency and Quantum Efficiency

The photon collection efficiency of a microscope system was measured in order to estimate the quantum efficiency of the SWCNT single-photon emitters. While operating the excitation laser at 900 nm, it was coupled into the system and focused on a gold substrate through the microscope objective. The laser beam was reflected by the substrate (with reflective losses being near-zero) and passed through exactly the same collection light path as experienced by the sample photoluminescence emission (note that the original long pass filter used to block the excitation beam was removed for this measurement). The laser power was measured at the substrate and before the detector, with the ratio giving a collection efficiency around 0.2%, including losses from the microscope objective, beam splitter, mirrors, and fiber coupling. Accounting for a detector efficiency of ˜25%, a combined collection and detection efficiency of ˜0.05% was determined. Given the measured count rate under pulsed excitation of ˜6 kHz for a PFO-bpy wrapped (6,5) tube, a corrected emission rate of around 12 MHz was obtained. Taking into account the laser repetition rate of 89 MHz, the quantum efficiency for single photon emission was estimated as ˜13.4%

A quantum efficiency for defect-state emission under continuous wave excitation for PFO-bpy-wrapped (6,5) nanotubes emitting around 1300 nm was estimated. Defect-state emission intensity observed under varying continuous wave excitation powers is shown in FIG. 11. A count rate of ˜120 kHz is observed in the saturation region. Using a determined photon collection/detection efficiency of 0.05%, a corrected emission rate of 200 MHz was determined. As a conservative estimate, using a longest measured emission lifetime of 0.6 ns, the quantum efficiency for single photon emission is then estimated as ˜11.9%, which is consistent with the result obtained for pulsed excitation.

### Substrate Effects on Functionalized and Unfunctionalized (6,5) SWCNT Photoluminescence Spectra

Unfunctionalized (6,5) SWCNTs, and those functionalized by 3,5-dichlorobenzene diazonium (Cl₂-Dz), were deposited from aqueous 1% DOC suspensions onto bare glass substrates and those coated with a thin layer of polystyrene (PS) (˜160 nm), with equivalent deposition volumes onto each substrate. Wide-field photoluminescence images and ensemble spectra were then compared (FIGS. 12A through 12C). Spectra were obtained by performing wide-field excitation while collecting all photoluminescence from the illuminated area into the spectrometer system. Images and spectra of functionalized SWCNT on the glass coverslip show significantly lower photoluminescence intensities than those deposited on the polystyrene-coated substrates.

### Defect-State Emission Linewidth Distributions for DOC and PFO-Bpy-Wrapped (6,5) SWCNT

Emission peak linewidths are weakly sensitive to the SWCNT wrapping environment at room-T, with PFO-bpy-wrapped (6,5) samples having slightly narrower linewidths compared to DOC wrapped ones at room-T. Shown in FIGS. 13A and 13B are histograms of observed defect-state emission linewidths (for emission peaks between 1.1 to 1.3 μm), obtained from fifty DOC and PFO-bpy wrapped (6,5) SWCNTs, each functionalized with Cl₂-Dz. Average linewidths were 33 meV (DOC wrapping) and 29 meV (PFO-bpy wrapping).

### CONCLUSIONS

Rational control and introduction of defect sites for exciton localization in low-dimensional materials is a promising approach for introducing quantum emission behavior. As demonstrated in SWCNTs, this approach brings several unique advantages not available with other materials. Most significantly, the inherent tunability of nanotube optical properties allows covalently-introduced defects to be harnessed to achieve generation of room-T SPE at the telecom wavelengths of 1.3 and 1.55 μm. Aryl sp³ dopants in particular are found to introduce a number of exceptional characteristics, including high emission rates (10⁵-10⁷ s⁻¹), single-photon purity (0.99 for g⁽²⁾(0) of 0.01 shown in FIG. 2), and shot noise-limited emission stability. While development of SWCNT-based SPEs are at an early stage, such performance metrics already compare well to more mature SPE materials. SWCNT potential for versatile integration into optoelectronic and photonic device structures holds significant future promise for further harnessing and enhancement of their SPE behaviors. Furthermore, an expanding availability of molecular dopant classes illustrates the tremendous potential that covalent defects have for expanding control over SWCNT emission properties through synthetic modification of dopants to further tune and enhance photonic response, as well as introduce new functionality that can be directly paired with these promising quantum emission behaviors.

While the present disclosure has been particularly described in conjunction with specific embodiments, it is evident that many alternatives, modifications, and variations will be apparent to those skilled in the art in light of the foregoing description. It is therefore contemplated that the appended claims will embrace any such alternatives, modifications, and variations as falling within the true spirit and scope of the present disclosure.

What is claimed is:

1. A method, comprising:
obtaining a single-wall carbon nanotube;
doping the single-wall carbon nanotube to provide a doped single-wall carbon nanotube; and
causing the doped single-wall carbon nanotube to emit single photons at room temperature.

2. The method of claim 1, wherein the causing:
exposing the doped single-wall carbon nanotube to at least one of about 840 nm or about 870 nm femtosecond laser pulses.

3. The method of claim 2, wherein the femtosecond laser pulses are performed at a repetition rate of about 90 MHz.

4. The method of claim 2, wherein the causing comprises:
exposing the doped single-wall carbon nanotube to a continuous output of a Ti:Sapphire laser.

5. The method of claim 4, wherein the continuous output is one of about 840 nm or about 870 nm.

6. The method of claim 1, wherein the doped-single-wall carbon nanotube has a chirality of (6,5) and wherein the single photons are emitted at wavelengths of about 840 nm to about 1000 nm.

7. The method of claim 1, wherein the doped single-wall carbon nanotube has a chirality of (7,5) and wherein the single photons are emitted at wavelengths of about 840 nm to about 1030 nm.

8. The method of claim 1, wherein the doped single-wall carbon nanotube has a chirality of (10,3) and wherein the single photons are emitted at wavelengths of about 840 nm to about 1230 nm.

9. The method of claim 1, wherein the doped single-wall carbon nanotube has at least one spa defect site.

10. A single photon source, comprising:
a single-wall carbon nanotube capable of emitting single photons at room-temperature.

11. The single photon source of claim 10, wherein the single-wall carbon nanotube has a (6,5) chirality.

12. The single photon source of claim 10, wherein the single-wall carbon nanotube has a (7,5) chirality.

13. The single photon source of claim 10, wherein the single-wall carbon nanotube has a (10,3) chirality.

14. The single photon source of claim 10, wherein the single-wall carbon nanotube is doped with an aryl compound comprising diazonium.

15. The single photon source of claim 14, wherein the aryl compound comprises 3,5-dichlorobenzenediazonium (Cl₂-Dz).

16. The single photon source of claim 14, wherein the aryl compound comprises 4-methoxybenzenediazonium (MeO-Dz).

17. The single photon source of claim 10, wherein the single-wall carbon nanotube is encapsulated in at least one of a surfactant or a polymer.

18. The single photon source of claim 17, wherein the surfactant comprises sodium deoxycholate (DOC).

19. The single photon source of claim 17, wherein the polymer comprises a polyfluorene polymer.

20. The single photon source of claim 19, wherein the polymer comprises 9,9-dioctylfluorenyl-2,7-diyl and bipyridine (PFO-BPy).
